(19) United States
(12) Patent Application Publication
(10) Pub. No.: US 2002/0077984 A1
(43) Pub. Date: Jun. 20, 2002

(54) Enabling protected digital media to be shared between playback devices

(76) Inventor: Mark Ireton, Portland, OR (US)

Correspondence Address: FENWICK & WEST LLP, TWO PALO ALTO SQUARE, PALO ALTO, CA, 94306, US

(21) Appl. No.: 09/747,351

(22) Filed: Dec. 19, 2000

(51) Int. Cl. G06F 17/60

(52) U.S. Cl. 705/51

(57) ABSTRACT

One embodiment of the present invention provides a media server. Another embodiment of the present invention provides a system for enabling protected media content to be shared between playback devices. Another embodiment of the present invention provides a method for enabling protected media content to be shared between playback devices. Another embodiment of the present invention provides a method for maintaining a desired distribution of acquired rights to use associated with media content. Another embodiment of the present invention provides a method for integrating a new component into a system for enabling protected media content to be shared between playback devices.

### FIELD OF THE INVENTION

The invention relates to media content, and more particularly, to enabling the sharing of protected digital media between playback devices.

### BACKGROUND OF THE INVENTION

Digital media can represent information in a number of forms, including the likes of audio, video, software, text, graphics, or combinations thereof. As such digital media proliferates and is distributed to consumers, various protection mechanisms are developing to ensure that digital media is not subjected to unintended or illegal use, such as unauthorized copying and redistribution. As a consequence of these protection mechanisms, a number of prescribed usage rules are associated with each piece of distributed digital media. Ideally, the consumer is obligated to treat acquired digital media in accordance with any prescribed usage rules associated with that digital media. Similarly, manufactures of digital recording devices are obligated to ensure that their recording devices operate within the constraints of prescribed usage rules.

One problem with this situation is that the consumer is significantly burdened by having to keep track of such prescribed usage rules. This problem is exacerbated by the fact that different pieces of digital media are likely to have different prescribed usage rules. Thus, consumers cannot rely on uniformity of usage rules to lessen their burden. In addition, consumers can simply overlook usage rules associated with a piece of digital media when possible. Moreover, currently available digital recording devices provide inadequate mechanisms for ensuring prescribed usage rules are not violated. As a result, content suppliers and distributors are discouraged from disseminating digital media knowing that prescribed usage rules can be readily disregarded.

There is a need, therefore, for techniques that facilitate the management of rights associated with digital media. Such techniques would allow consumers to escape the burden of having to keep track of prescribed usage rules. Likewise, such techniques would preclude violation of prescribed usage rules thereby encouraging content suppliers and distributors to disseminate digital media.

### BRIEF SUMMARY OF THE INVENTION

One embodiment of the present invention provides a media server including an input unit having a number of input ports for receiving media content, an intake module operatively coupled to the media input unit for identifying rights to use associated with the received media content, a storage unit operatively coupled to the intake module for storing rights to use associated with the received media content, and an outtake module operatively coupled to the storage unit and for transferring rights to use associated with the media content to another location.

Another embodiment of the present invention provides a system for enabling protected media content to be shared between playback devices. The system includes a media server for transferring rights to use associated with media content to other locations on the system thereby allowing copies of that media content to be used at the other locations, and a playback device accessible by the media server. The playback device allows playback of the media content given that a right to use associated with that media content has been transferred to the playback device. One embodiment of this system includes a number of media servers and playback devices, and rights to use associated with acquired media content can be distributed among system components pursuant to a distribution scheme.

Another embodiment of the present invention provides a method for enabling protected media content to be shared between playback devices. The method includes receiving media content, identifying rights to use associated with the received media content, and transferring rights to use associated with the media content to another location thereby allowing playback of that media content at that location. One embodiment of this method includes distributing rights to use pursuant to a scheme.

Another embodiment of the present invention provides a method for maintaining a desired distribution of acquired rights to use associated with media content by determining whether the acquired rights to use are properly distributed based on indicators. In response to the acquired rights to use not being properly distributed, the method includes redistributing the rights to use based on a scheme. One embodiment of this method includes queuing redistributed data bound for a target location that is unavailable at redistribution time until that location becomes available at a later time.

Another embodiment of the present invention provides a method for integrating a new component into a system for enabling protected media content to be shared between playback devices. The method includes connecting a new component to the system, associating the new component with an identity, notifying existing components of the new component's identity, creating a secure communication link between the new component and an existing component, exchanging information about the system thereby integrating the new component into the system, and redistributing rights to use associated with the protected media content in accordance with system configuration rules.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a block diagram of a media system in accordance with one embodiment of the present invention.

FIG. 2 illustrates a block diagram of a digital media server in accordance with one embodiment of the present invention.

FIG. 3 illustrates the flow of digital media and its associated rights in a media system in accordance with one embodiment of the present invention.

FIG. 4 illustrates a method for enabling protected media content to be shared between playback devices in accordance with one embodiment of the present invention.

FIG. 5 illustrates a method for maintaining a desired distribution of rights associated with digital media in accordance with one embodiment of the present invention.

FIG. 6 illustrates a method for integrating a new component into a system for enabling protected media content to be shared between playback devices in accordance with one embodiment of the present invention.

### DETAILED DESCRIPTION OF THE INVENTION

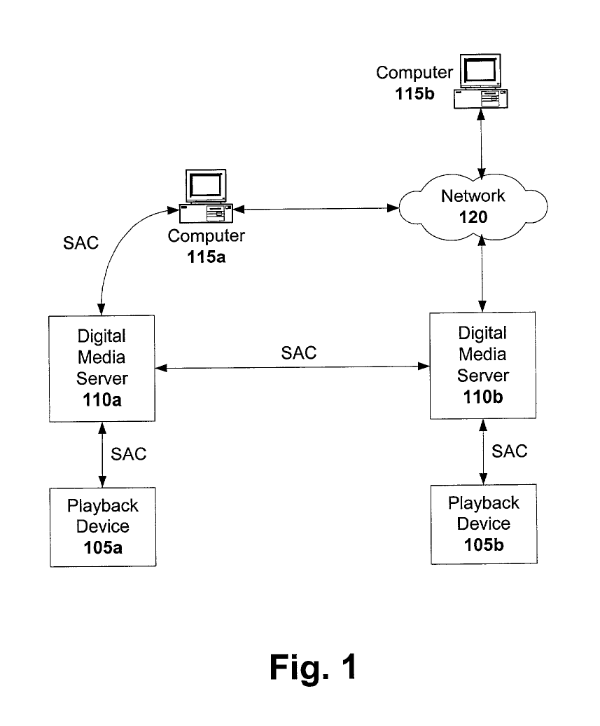

FIG. 1 illustrates a block diagram of a media system in accordance with one embodiment of the present invention. The system includes a number of playback devices 105 (e.g., 105a and 105b), a number of digital media servers 110 (e.g., 110a and 110b), and a number of computers 115 (e.g., 115a and 115b) operatively coupled to one another via a network 120.

Overview

The system allows a consumer of digital media to have access to copies of that digital media in a number of locations without violating prescribed usage rules associated with the digital media. For instance, assume a digital book or digital music track purchased by a consumer is associated with a usage rule that the consumer can only have three working copies of the digital book. Further assume the consumer desires to have a first copy of the digital book or music track on computer 115b at the office playback device 105 associated with computer 115b not shown), a second copy on playback device 105a in the living room at home, and a third copy on playback device 105b in the bedroom. The system and techniques described herein provide a means for transferring the right to enjoy or otherwise use a piece of digital media (such as a digital book) between playback devices 105 while ensuring that the overall usage rules for that particular piece of digital media are not violated by the consumer.

For example, the right to enjoy or otherwise use a copy of the digital book or music track located on computer 115b can be implicitly transferred (e.g., via an accounting mechanism) or explicitly transferred (e.g., via movement of a decryption key) to computer 115a located in a den or study at home. This might be desirable because the user no longer needs the right to use the digital book or music track at the office. As such, the right to use associated with the copy on computer 115b is effectively transferred to computer 115a. A copy of the digital book or music track located on computer 115a can now be available for use. Digital media servers 110 provide a mechanism for effecting and managing the secure transfer of rights to use between the various components of the system.

Note that whether the copy of the digital book or music track that resides on computer 115b is actually removed is irrelevant. Even if a copy still resides on computer 115b, the right to use that copy is no longer present. Thus, the copy on computer 115b cannot be used. In this way, the actual number of copies made of an acquired piece of digital media can be unlimited. As such, each playback device 105 of a given system can have a copy of a piece of acquired digital media. However, at any given time, only those copies accompanied by a right to use can be enjoyed or otherwise used. Moreover, each copy is encrypted or otherwise protected thereby inhibiting unauthorized copying of a copy. The usage rules associated with the particular piece of digital media define the total number of working copies of that piece of digital media.

The system can be deployed in a home, office, or any location where a consumer might be interested in using digital media. Alternatively, the system can span across several different locations such as both the home and office, or multiple homes. Some or all of the components included in the system can be coupled to one another via a dedicated connection such as a hardwire connection or a wireless communication link. Likewise, some or all of the components included in the system can be coupled to one another via a network-type connection such as a local area network within a home or office, or a wide area network (including the Internet) between remote locations. Generally stated, the system is not constrained by geographic limitations given access to conventional communication infrastructures such as the Internet, telephone lines and cable systems. A secure and authenticated channel over such communication infrastructures can be used to transfer digital media and or its associated rights.

As earlier stated, digital media can represent information in a number of forms, including the likes of audio (e.g., MP3 and WAV files), video (e.g., MPEG and QuickTime. files), software (e.g., games and word processing applications), text (e.g., HTML documents and document files), graphics (e.g., GIFF and JPEG files), or combinations thereof. Digital media includes, for example, digital books, digital audio books, digital music, digital movies, digital lectures or other educational presentations, digital art, computer games, or any digital data file that can be executed or otherwise used by a consumer. The techniques described herein can be employed in the context of any such digital media.

In addition, the system is not limited to any one kind of media, whether the media be in digital form or otherwise (e.g., analog form). Rather, the system can operate in the context of a number of diverse media forms such as compressed encrypted digital music, bitmap images, object code, and analog music signals. Non-digital media content can be converted to digital to facilitate use of that media content by the system. Thus, the same system can be used to facilitate the playback of, and manage the rights associated with, various acquired digital books, digital or analog music, digital artwork, and other forms of media content.

Note that alternative embodiments of the system might include other components not shown in FIG. 1, such as additional playback devices 105, additional digital media servers 110, additional networks 120, encryption/decryption modules, buffers, queue structures, and storage units. Similarly, alternative embodiments of the system need not include all the components shown in FIG. 1. For instance, a system may include one digital media server 110 and a number of playback devices 105. Each of the components shown in FIG. 1 will now be discussed in more detail.

Components

A playback device 105 can be any of a number of devices configured to allow a consumer to enjoy or otherwise use acquired digital media. For instance, a playback device 105 for enjoying digital graphics such as digital artwork (e.g., digitized version of the Monet's Rouen Cathedral or an original piece of digital artwork) might be an application running on a computer, personal digital assistant, or other processing environment capable of displaying images of digital graphics. Additionally, a playback device 105 for enjoying digital graphics might be a projector that projects a high-resolution image of a digital graphic onto a wall or other surface.

In the context of digital audio files such as digital music, playback device 105 might be a boom box, a portable audio player, a car stereo, or an application running on a computer or other processing environment capable of sounding out a digital audio file. In the context of digital text files such as digital books, playback device 105 might be a hand held electronic device capable of storing and displaying digital text (e.g., a personal digital assistant), or an application running on a computer or other processing environment capable of displaying a digital text file. Generally, a playback device 105 need not include storage capability. Rather, playback devices 105 need only the ability to playback a particular piece of digital media that is stored elsewhere on the system. However, playback devices 105 may optionally include storage capability. Numerous other playback devices 105 will be apparent in light of this disclosure. Note that a computer 115 can also include a playback device 105.

Generally, a computer 115 can be a conventional computer system such as a desktop, laptop or workstation. Likewise, computer 115 can be a server or data vault for storing and serving various forms of digital media. Similarly, computer 115 can be a processing device such as a personal digital assistant or other electronic devices capable of communicating with other system components.

A digital media server 110 is capable of managing the transfer of digital media and associated user rights to components included in the system. In one embodiment, digital media server 110 is a conventional computer having a set of software instructions stored therein that, when executed, facilitate the managing and transfer of digital media and associated user rights. However, digital media server 110 can be implemented in the likes of hardware, software, firmware, or any combination thereof. For example, digital media server 110 might be a microcontroller unit or single board computer having a central processing unit and support features such as RAM, ROM, buffers, and a nonvolatile storage facility (e.g., flash memory or electronic erasable programmable ROM). In such an embodiment, a process, algorithm or otherwise executable instruction set could be stored in the ROM and loaded into the RAM for execution thereby carrying out the management and transfer of digital media and or associated user rights. Such digital media and associated user rights could be stored in the nonvolatile storage facility.

The physical form of digital media server 110 may be adapted to the environment in which it is deployed. For example, a digital media server 110 might be implemented in whole or in part on a computer card that is installed in a conventional computer. In such an embodiment, the computer card could have access to a hard drive of the computer or other external storage device for storing various forms of digital media and or the rights associated therewith. Alternatively, digital media server 110 can be contained in a housing that is configured to fit within the likes of a dash or trunk of a vehicle. Similarly, digital media server 110 can be contained in a housing that is suitable to sit in plain view on a desktop or on a shelf of an entertainment center. In short, digital media server 110 can be integrated into a larger multifunctional system or can stand on its own, and can have a number of physical forms depending on factors such as desired aesthetic, user interface qualities, and compactness.

A digital media server 110 can be coupled to a number of system components on a permanent basis. Likewise digital media server can be coupled to various system components only when a transfer of digital media and associated rights is taking place. For example, a portable digital music player may be temporarily coupled to a digital media server 110. During such a temporary coupling, a right to use associated with a digital music track deleted from the portable digital music player can be transferred to a media server 110. In addition, a new digital music track and its associated right to use can be transferred from the digital media server 110 to the portable device.

Note also that while some digital media servers 110 included in the system can both transmit and receive digital media and or associated user rights, other digital media servers 110 may primarily only receive digital media and associated user rights depending on their location in the system. For example, a digital media server 110 located in a car might only receive digital media and associated user rights, while a digital media server 110 in the family room will both transmit and receive digital media and or associated user rights to and from other system components. However, digital media and or associated user rights stored in a car digital media server 110 (or other receiving-type digital media server 110) can be transferred back to other system components if so desirable.

In one embodiment, each connection to other system components (whether a permanent or temporary connection) is established with a secure authenticated channel (SAC). Generally, a SAC is a mechanism for communicating digital data between two system components over a connection (“channel”) that is secure by virtue of the encrypted or otherwise encoded digital data. In addition, each component can verify or authenticate the identity of other components included in the system. The security of a SAC prevents data (e.g., a copy of a piece of digital media, the user rights associated with a piece of digital media or both) from being illicitly copied, used or otherwise tampered with as it is transferred between devices. The authentication of SAC enables transmitting system components to verify that a destination system component is a valid recipient of the transferred data thereby preventing intruders or other non-system components from receiving the data.

The communication between two system components by way of a SAC can be over, for example, a network connection (e.g., Internet or local area network), a bus connection (e.g., universal serial bus, IEEE 1394 bus, or other bus technology), or a cable. Likewise, the communication between two system components by way of a SAC can also be established by a wireless connection such as an infrared, radio frequency or microwave communication channel (sometimes referred to as a communication link). Conventional wireless transmitter and receiver technology can be employed to realize such a wireless connection between system components. In addition, conventional encryption or encoding techniques can be employed to secure the communication channel (e.g., proprietary protection schemes of content providers or a homogenizing protection scheme employed by digital media servers 210). Regardless of how the components of the system are coupled together, a SAC can be established between communicating components thereby ensuring a secure and authenticated channel of communication. Note that other technologies for securing a communication channel can be employed as well, such as that used in electronic money transfers.

In the embodiment shown, assume the following: playback device 105a is a portable digital music player; playback 105b is a boom box in the user's living room; digital media server 110a is portable, but is primarily located in the user's car; digital is media server 110b is located on a shelf of an entertainment center in the user's living room; computer 115a is a laptop that the user generally keeps around the house; computer 115b is a work station located at the user's office; and network 120 is the Internet. Further assume that all of the user's acquired digital media collection is stored in digital media server 110b. In such an embodiment, the user has access to the acquired digital media from a number of locations, whether local or remote. Sub-sets of the acquired digital media collection can be stored on other components included in the system.

For instance, the user can employ computer 115b at the office to access digital media server 110b via network 120. A SAC is established across network 120 by digital media server 110b once computer 115b is identified as a valid system component. The user can then securely download various pieces of digital media from digital media server 110b. The associated user rights can be transferred with the digital media (e.g., embedded in the digital media or contained in the same transmission), or separately from the digital media. Similarly, if an actual copy of the digital media the user wants to use is already located on computer 115b, then only the right to use that particular piece of digital media need be transferred from digital media server 110b to computer 115b. Note that transferring the right to use a piece of digital media is easier than transferring the actual piece of digital media in that the right might represent a kilobyte of data while the digital media itself might represent several megabytes of data. Once the user no longer desires to use a particular copy of digital media at work, the associated right to use can be securely transferred back to digital media server 110b. Thus, that right to use will be available for a different playback location.

The user can use computer 115a to surf the Internet for various pieces of digital media and or the associated user rights. For example, computer 115a can be used to download digital music files and the associated user rights from online digital music providers. The downloaded digital music files and associated user rights can then be provided, for example, to digital media server 110a in the car via a SAC. On the other hand, if the user already owns a copy of a particular piece of digital media, then only additional rights to use need be downloaded from the online digital music providers. Such rights can then be provided to digital media server 110a.

Digital media server 110a is shown with a SAC connection between itself and playback device 105a, as well as between itself and digital media server 110b. As stated earlier, such connections can be temporary or permanent. In this case, given that digital media server 110a is located in a car, the SAC connections are temporary. For instance, playback device 105a is temporarily coupled with digital media server 110a via a SAC so that a number of digital songs and or their associated rights to use can be transferred from the digital media server 110a to playback device 105a. Thus, the user can continue enjoying those digital songs during a hike after enjoying them in the car on the drive to the hiking area. In addition, digital media server 110a can be temporarily coupled to digital media server 110b via a SAC so that digital media and or associated user rights contained in digital media server 110a can be provided to digital media server 110b in the living room (and vice versa). As such, the user can have access to that digital media in other locations, such as on playback device 105b in the living room, or on computer 115b at the office.

The system can operate in accordance with system configuration rules or preferences set by the user. For example, the user can define default locations within the system for each piece of acquired digital media and associated user rights. As various pieces of digital media are transferred about the system during the course of the user's day, digital media server 110a or 110b or a combination of the two can track the transfers and maintain related information such as current locations of each piece of digital media, the number of rights to use associated with each piece of digital media, and the location of each such right to use. Media server 110a or 110b or a combination of the two can redistribute the copies of acquired digital media and or associated user rights to their default locations on a periodic basis. For instance, the redistribution of copies of acquired digital media and or rights to their default locations could be performed automatically at 2 a.m. on a daily basis. In such an embodiment, the user would wake up in the following morning knowing exactly where each piece of digital media was available for use. Programmed default locations can be different from, for example, one hour to the next or one day to the next based on factors such as the user's fancy and the user's planned schedule for the upcoming hour, day, week or weekend. Thus, the user can precisely control the digital contents of a particular playback location at any given time.

In the case where a default location for a particular piece of digital media and or associated user rights is a component that is unavailable at distribution time (e.g., the component is down or not currently coupled to the system), then the scheduled redistribution related to that particular component can be queued (e.g., in digital media sever 110a or 110b). Once the component becomes available, the scheduled redistribution can occur. For example, as a portable digital music player, playback device 105a might not be coupled to digital media server 110a at a scheduled redistribution time. The next time playback device 105a is coupled via a SAC to either of digital media servers 110a or 110b, the scheduled redistribution can take place. Note that if a number of scheduled redistributions have occurred without the presence of a particular component, then the aggregate effect of those redistributions can be determined, and the component will be updated accordingly.

Numerous other system components and configurations will be apparent in light of this disclosure and the present invention is not intended to be limited to any one embodiment. For instance, digital media server 110b might be integrated into a computer system thereby allowing a user to acquire digital media directly from the Internet to digital media server 110b. Alternatively, digital media server 110b can be operatively coupled to a web crawling application that is configured to search the Internet for a particular kind of digital media. The communication channel used to download digital media from content suppliers on the Internet may be protected (e.g., SAC) or unprotected (e.g., conventional non-encrypted digital subscriber line). Moreover, mechanisms other than SACs can be used to ensure a robust and secure communication channel or link (e.g., electronic money transfer technology) for transferring digital data between system components.

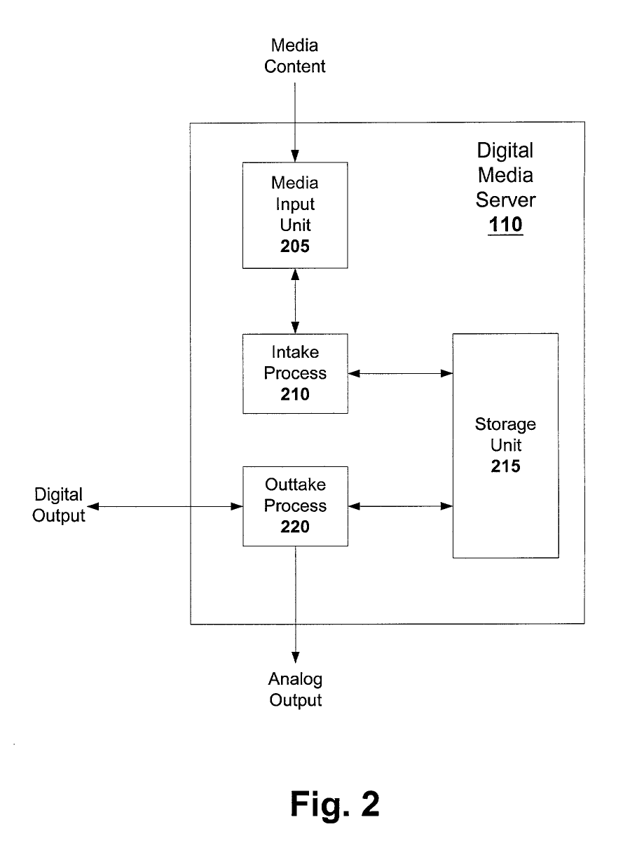

FIG. 2 illustrates a block diagram of a digital media server in accordance with one embodiment of the present invention. Digital media server 110 includes a media input unit 205, an intake process 210, a storage unit 215, and an outtake process 220. Generally, media content is received by digital media server 110 and provided to media input unit 205. The received media content is then subjected to intake process 210, and can be stored in storage unit 215. The media content stored in storage unit 215 can be subjected to outtake process 220 and provided to other system components via the digital output. In addition, media content stored in storage unit 215 can be subjected to outtake process 220 and provided to the analog output for playback on analog-type devices (e.g., audio speakers). Each component of digital media server 110 will now be discussed in more detail.

The media content received by digital media server 110 can either be in a protected form or an unprotected form. Protected media content, for example, might have been purchased in a digital form from an online content supplier, or from a bricks and mortar retail store. With reference to FIG. 1, protected media content can also include digital media from another system component such as an additional digital media server 110 or a playback device 105. Unprotected media content, on the other hand, might be obtained, for example, from the likes of tapes, films, compact discs, and vinyl record albums. Likewise, unprotected media content might include scans of graphic illustrations, photographs, or other images. In addition, unprotected media content might include free digital content obtained from a source available online.

Thus, the media content received by digital media server 110 can be protected or unprotected, and can have a number of forms including analog and digital. Given the various forms that the media content can come in, media input unit 205 can be configured accordingly. For example, media input unit 205 can include analog inputs such as an RCA jack, a miniplug, a RJ-type phone connector, a microphone or other analog-based input mechanisms. In addition, media input unit 205 can include digital inputs such as data ports, busses or other digital-based input mechanisms.

Intake process 210, which can be implemented in the likes of hardware, software, firmware or any combination thereof, prepares the received media content for storage in storage unit 215. For example, intake process 210 can perform analog to digital conversion on received media content having an analog form. If desirable (e.g., because of limited storage space), intake process 210 can perform digital compression on digital media content, whether received in digital form or converted to digital from a received analog form. Note, however, that media content may already be compressed when received by intake process 210, and also that media content need not be digitally compressed but can be stored in its uncompressed form. In addition, intake process 210 can identify the user rights associated with a piece of protected media content.

Decryption of protected digital media can be performed by intake process 210 as well. For example, digital media may be received from a content supplier in a proprietary encrypted form. Such protected digital media can be decrypted and then re-encrypted with encryption techniques associated with the present invention. In this way, each piece of digital media stored in a digital media server 110 could be encrypted under the same encryption scheme as opposed to a number of different proprietary encryption schemes. Thus, only one encryption scheme would have to operate once digital media was loaded into digital media server 110 thereby reducing the amount of determinations that would have to be made in transferring a piece of digital media. This re-encryption can be referred to as a homogenized protection scheme. Note, however, that intake process 210 need not decrypt incoming digital media.

In one embodiment, content providers can provide full-use of proprietary decryption keys and methodologies required to decrypt the received digital media as part of a trust-based relationship between the content providers and users of the system and techniques provided herein. A mandate under such a trust-based relationship would require that once stripped of its proprietary protection scheme, the digital media would never be vulnerable to unauthorized use. This mandate could be satisfied, for example, by re-encrypting or otherwise encoding the digital media, or by storing the decrypted digital media to proprietary hardware (e.g., digital media server 110). Numerous homogenized protection schemes which will be apparent in light of this disclosure, whether based in the likes of conventional encryption, proprietary hardware, binding, encoding or combinations thereof, can be employed to satisfy the mandate and sustain the trust-based relationship. The present invention is not intended to be limited to any one such protection scheme.

The resulting digital files and their associated user rights (if any) are then provided by intake process 210 to storage unit 215. Note that if no user rights are associated with a particular piece of digital media, then default user rights can optionally be assigned. Storage unit 215 can be, for example, a magnetic hard drive or a compact disk drive configured to record. Alternatively storage unit 215 can be a number of solid-state storage devices such as electronic erasable programmable read only memory (EEPROM) chips or flash memory chips. Other suitable storage devices and means will be apparent in light of this disclosure. In one embodiment, storage unit 215 or a portion of storage unit 215 includes a secure database for storing the likes of digital media and or associated user rights, whether those rights are implicitly represented or explicitly represented.

Outtake process 220 prepares the digital media stored in storage unit 215 for transfer to other locations. For example, outtake process 220 can decompress any digital compressed digital media. In addition, outtake process 220 can establish a SAC between itself and the intended recipient and package the digital media to be transferred into the SAC. For example, outtake process 210 can perform encryption of digital media (if the media was not stored encrypted) using conventional public-private key encryption techniques. This renders the digital media secure, and allows for the communication channel to be implicitly authenticated in that only a controlled number of components will have the private key necessary to unlock and use the transferred digital media. As such, the resulting decompressed, encrypted digital files and or their associated user rights can be provided from the digital output to other components via a SAC.

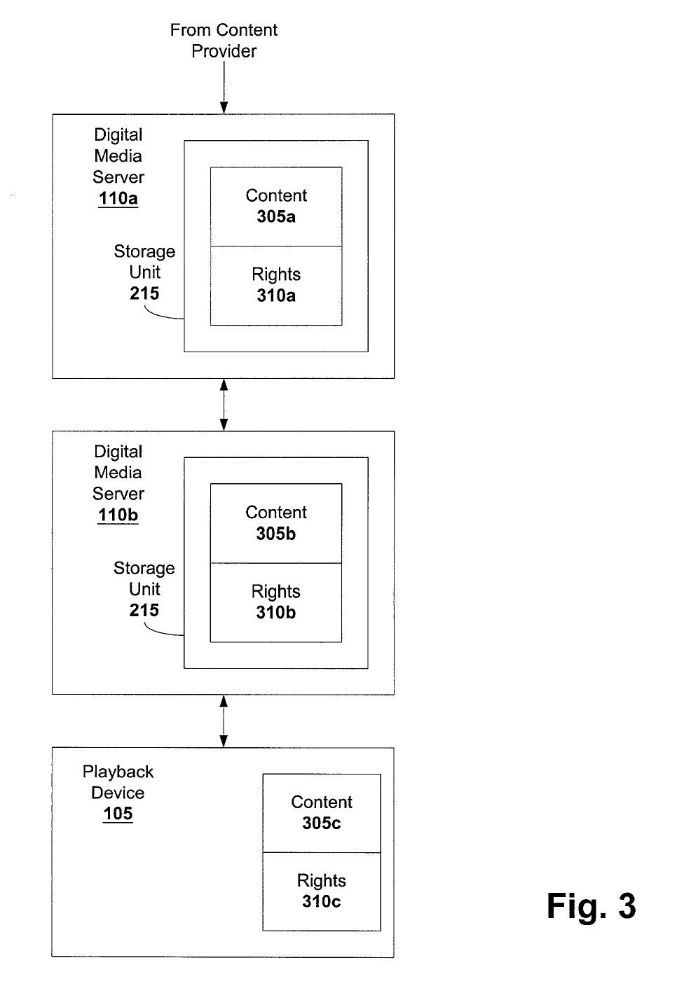

Outtake process 220 can also perform digital to analog conversion and provide the analog result to the analog output of digital media server 110. In one embodiment, the analog output can be provided to an amplifier having an output that is provided to a number of speakers for sounding out stored music. In such an embodiment, the amplifier and speakers can be included in digital media server 110 as well, but may also be external components. Like intake process 210, outtake process 220 can be implemented, for example, in hardware, software, firmware or any combination thereof FIG. 3 illustrates the flow of digital media and its associated rights in a media system in accordance with one embodiment of the present invention. For purposes of a hypothetical example, assume that a piece of digital music is received by digital media server 110a from a content provider. This music may be purchased electronic music distribution (EMD) content, or it may be non-protected media content in analog form to which default user rights can be applied by digital media server 110a (although default rights need not be assigned and such media content can remain unprotected). Regardless is of the source of the associated user rights, assume that the associated user rights allow the user to reproduce up to five copies of the piece of digital music. Initially, all of the rights reside on digital media server 110a. In the embodiment shown, storage unit 215 of digital media server 110a stores both the piece of digital music (content 305a) and all five rights to use (rights 310a).

Digital media server 110a might be physically located, for instance, in the user's family room. Digital media server 110b, on the other hand, might be physically located in the user's car. Regardless of the location of each digital media server 110, the user can implicitly or explicitly transfer three of the five rights to use the digital music from digital media server 110a to digital media server 110b. If a copy of the digital music is not already on digital media server 110b, then a copy of the digital music can also be transferred to digital media server 110b. Storage unit 215 of digital media server 110b can securely store both the piece of digital music (content 305b) and the three transferred rights to use (rights 310b). Note that the transfer of the digital music and the associated user rights from digital media server 110a to digital media server 110b can be accomplished via a SAC established by digital media server 110a in order to comport with protection goals.

Continuing with the hypothetical, assume that at some later point in time the user transfers a single right to listen to the digital music from digital music server 110b to playback device 105 (e.g., a portable digital music player), again accompanied by a transfer of the actual musical content if necessary. Thus, the newly acquired digital music is now located in three locations. A first copy (content 305a) resides on digital media server 110a and is associated with two rights to use (rights 310a), a second copy (content 305b) resides on digital media server 110b and is associated with two rights to use (rights 310b), and a third copy (content 305c) resides on playback device 105 and is associated with one right to use (rights 310c). Note that the transfer of the digital music and the associated user rights from digital media server 110b to playback device 105 can be accomplished via a SAC established by digital media server 110b.

Now assume that the next time the user transfers digital music and or rights to playback device 105, it is connected to digital media server 110a (e.g., the user is now in the living room instead of the car). The rights to use associated with files that have been deleted from playback device 105 can be transferred back to digital media server 110a. With this point in mind, assume that the user has deleted the recently downloaded digital music file in order to make room for new content. Thus, the right to use (rights 310c) associated with the deleted digital music is transferred back to digital media server 110a. As such, three rights to use the digital music now reside on digital media server 110a in the living room, and two rights to use the digital music remain on digital media server 110b in the car server. The user still has access to five rights to use the digital music and therefore has lost no rights. The right to play an additional copy of the content may now be transferred, implicitly or explicitly, from digital media server 110a back to digital media server 110b at some later time. Numerous other flows of digital media and or its associated rights will be apparent in light of this disclosure. For example, a flow of user rights might have been from digital media server 110a to playback device 105 to digital media server 110b and back to digital media server 110a.

Implicit Transfer

In one embodiment, the rights to use a particular piece of digital media are is implicitly transferred by initializing, decrementing, or incrementing a rights counter associated with that piece of digital media. For example, the rights to use associated with the digital music discussed in the hypothetical above are implicitly transferred by decrementing a rights counter included in digital media server 110a from five to two, and initializing a rights counter included in digital media server 110b to three. The rights counter of digital media server 110a could have been initialized to five when digital media server 110a initially received the digital music. For example, intake process 210 (shown in FIG. 2) could perform this counter initialization. Outtake process 220 could then decrement the rights counter to two upon transferring the three rights to use to digital media server 110b. Similarly, a rights counter included in digital media server 110b could be initialized to three when digital media server 110b initially received the digital music and or the associated three rights to use.

Note that if digital media server 110a already had a copy of the digital music and was only receiving additional rights to use from the content provider, then the digital media server 110a rights counter associated with that digital music would not need to be initialized, but only incremented based on the number of newly acquired rights to use. Likewise, if digital media server 110b already had a copy of the digital music and was only receiving additional rights to use from digital media server 110a, then the digital media server 110b rights counter associated with that digital music would not need to be initialized, but only incremented based on the number of newly acquired rights to use.

In addition, note that the likes of incrementing, decrementing and initializing of rights counters can be performed locally (e.g., intake and outtake processes of receiving digital media server effect local rights counter function) or remotely (e.g., outtake process of transmitting digital media server issues command over SAC to intake function of receiving digital media server to effect remote counter function). Various configurations between digital media servers will be apparent in light of this disclosure. For instance, in one embodiment, one digital media server might be a master while the other digital media servers included in the system are slaves (however, note that no master is necessary). Alternatively, each digital media server can be dedicated to a particular group of system components.

Explicit Transfer

In one embodiment, the rights to use are explicitly transferred by transferring a decryption key. In such an embodiment, one decryption key is generated for each right to use the user has acquired for a particular piece of digital media. The associated digital media is stored encrypted, and any one of the decryption keys can be used to decrypt that encrypted digital media. Conventional encryption technology can be employed to effect this scheme. For example, the rights to use associated with the digital music discussed in the hypothetical above are explicitly transferred by transferring three of the five decryption keys from digital media server 110a to digital media server 110b. The five decryption keys of digital media server 110a can be generated when digital media server 110a initially received the digital music. In one embodiment, intake process 210 (shown in FIG. 2) could encrypt the received digital media and generate a corresponding decryption key for each acquired right to use. Outtake process 220 could then securely transfer the decryption keys accordingly. A log of the number of keys available and the current location of each decryption key can be maintained to ensure that decryption keys are not lost and can be readily transferred between playback locations.

Variations of explicit transfer techniques will be apparent in light of this disclosure. For example, a unique decryption key can be allocated for each copy of digital content thereby forming a number of key-content pairs. A key-content pair (rather then just a key) can be explicitly transferred from one location to another.

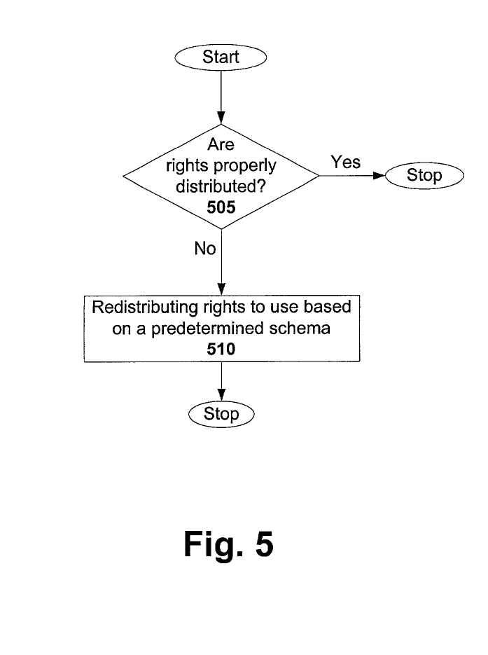

Note that additional information can also be explicitly transferred with a piece a digital media and or a user right. For instance, the location history over a preset time period (e.g., the last week) of a particular piece of digital media or a particular right to use can be contained in a data file that is embedded in the digital media or right to use (e.g., an encryption key or other vehicle for explicitly transferring a user right). Such a data file could be updated each time the piece of digital media or user right is transferred to a new location. In one embodiment, this update process could be performed by the outtake process 220 (FIG. 2). Such historical data would be desirable in defining patterns of use with regards to acquired digital media, and could be used to fine tune or otherwise adjust the automatic redistribution of rights to use as is discussed in reference to FIG. 5. As such, the need for redistribution can be minimized once a user's patterns of use are determined thereby further increasing the user's overall value of acquired digital media. Historical data could also be employed in a pay-per-use system (e.g., 2 cents a playback)

Other types of information that can be used to benefit the likes of the user and system performance will be apparent in light of this disclosure. For example, the type of digital media (e.g., music, art, books), the sub-class of each type of digital media (e.g., rock and roll music, impressionist art, science fiction books) and the number of playback devices that can be used to enjoy or otherwise use each type of digital media. Such information may be helpful in categorizing the various types of media content for purposes of establishing distribution preferences. For example, one playback device in the downstairs family room may generally be used for playing rock and roll music, while another playback device in the study may predominantly be used for playing classical music. Thus, if a particular piece of rock and roll music is associated with only one right to use, then that piece of music can appropriately be provided to the playback device in the downstairs family room rather than to the playback device in the study. Established distribution preferences can be developed based on factors such as prior use data or user-defined default settings. Numerous established distribution preferences will be apparent in light of this disclosure.

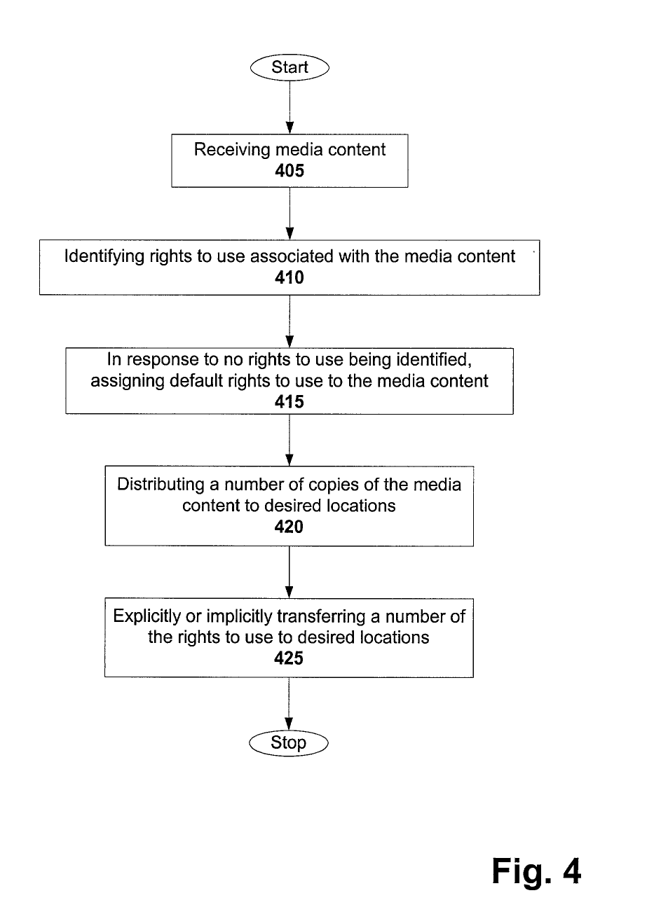

FIG. 4 illustrates a method for enabling protected media content to be shared between playback devices in accordance with one embodiment of the present invention.

This method could be implemented in a system as the one illustrated in FIG. 1. However, it is not intended that the method be limited to any one system or configuration. The method can be implemented, for example, in hardware, software, firmware or any combination thereof

The method begins with receiving 405 media content. This media content (e.g., music, art, books) may be protected or unprotected, and may be in a number of forms including digital or analog. The method proceeds with identifying 410 rights to use associated with the media content. The rights to use may be embedded in the media content or otherwise associated with the media content. Such rights to use can specify, for example, the number of copies that can be available for playback at any given time. In response to no rights to use being identified, the method may include assigning 415 default rights to use to the media content. Note that once assigned, default rights can be treated as if they were formal user rights originally received with the media content. Thus, it is intended that unprotected media content having assigned rights to use is effectively protected media content.

The method may include distributing 420 a number of copies of the media content to desired locations (e.g., a playback device or a digital media server). This presumes that the desired locations do not already have a copy of the media content, in which case no copy would need to be distributed to those particular locations (unless duplicate copies were desirable, so long as each copy was protected). A copy of the media content may also be provided to a secure storage device for future copying and distribution purposes. The method also includes explicitly or implicitly transferring 425 a number of the rights to use to desired locations. For example, one location (e.g., playback device) might receive a single right to use, while another playback location (e.g., digital media server) receives four rights to use. Note that a number of the rights to use may be provided to a secure storage device for future distribution purposes. Further note that the distribution of the actual media content can be separate from the distribution of rights to use that media content.

The method may include other steps not shown in FIG. 4 such as recording the location history of a particular piece of media content and or the rights to use associated with that piece of media content. Similarly, the method might include categorizing each piece of media content and or associated user rights based on type and sub-class as discussed above. Also, the method might include queuing distributed media content and or user rights in response to the target device being unavailable for whatever reason at distribution time. In such an embodiment, the method might further include distributing copies of the media content to previously unavailable playback locations in response to such locations becoming available. Likewise, the method might further include explicitly or implicitly transferring a number of the rights to use to previously unavailable playback locations as they become available.

In addition, the distribution of media content and or associated user rights can be performed pursuant to a predetermined distribution scheme. In one embodiment, for instance, the media content is distributed to each playback device on a given system. However, the rights to use those particular copies can be distributed to playback devices based on an established pecking order. For instance, if the user has ten possible playback devices that can be used to enjoy a particular piece of media content, but only has a total of five rights to use that media content, then each of the playback devices most likely to be used to enjoy the digital content will receive a right to use the media content. Note that any of the remaining un-favored five locations can have a right to use transferred to it at a later time if so desired. Further note that if the number of acquired rights to use a particular piece of media content is equal to or exceeds the number of available playback devices relevant to that media content, then a pecking order scheme is unnecessary. The pecking order of playback devices can be determined, for example, based on location history data including download rates and related statistics, and or established distribution preferences for that type of media content as discussed above.

Other distributions schemes will be apparent in light of this disclosure. For example, newly acquired media content and its associated user rights could initially be equally distributed to all digital media servers included in a given system in accordance with an overall system distribution scheme. Each digital media server can then effect a sub-system distribution scheme relevant to a number of system components supported by that particular digital media server. Distribution can include not only moving digital media and or associated rights, but also can include other functions such as deleting and copying (where allowed and if appropriate). Such functions can also be based on the likes of established patterns of use (on non-use) and user preferences.

FIG. 5 illustrates a method for maintaining a desired distribution of rights associated with digital media in accordance with one embodiment of the present invention. Again, such a method could be implemented in a system as the one illustrated in FIG. 1, though it is not intended that the method be limited to any one system or configuration. The method can be implemented, for example, in hardware, software, firmware or any combination thereof.

The method begins with determining 505 whether the acquired user rights are properly distributed based on established indicators. For example, each component on the system can be assigned a particular number of rights to use. A process running on a digital media server can survey the various components to determine if the desired number of rights to use is present at each device. If not, then determination 505 is negative. Otherwise, determination 505 is positive.

Alternatively, a transfer log that contains user rights transfer activity over a given period of time can be compared to a master location file that defines home positions for each of the acquired user rights. Differences between the transfer log and the master location file may result in determination 505 being negative. In one embodiment, the number of rights allocated for each location is a range thereby allowing more flexibility in transfers of user rights without effecting a redistribution. Similarly, some locations may have a more stringent requirement than others with regards to the number of user rights required to stave off a redistribution. Likewise, some pieces of media content stored at one location may be required to be accompanied by more associated user rights than other pieces of media content stored at that same location.

For example, rights to use one particular digital song are frequently transferred to other system components (e.g., portable digital music player) from a digital media server located in the living room, while rights to use another digital song are rarely transferred from that digital media server located in the living room. Thus, if any of the frequently transferred rights to use are missing, determination 505 can be negative thereby requiring redistribution. On the other hand, if any of the rarely transferred rights to use are missing, determination 505 can still be positive. In this way, the method includes active learning based on factors such as prior use patterns. Numerous variations on how determination 505 is effected will be apparent in light of this disclosure, and other factors can be considered as well. For instance, the user can manifest a desire that redistribution take place (e.g., press a button on the media server that sets an internal flag that is polled by the process for effecting determination 505). Additionally, the number of times a user has had to manually effect a transfer of rights to use during a particular time period can be sensed thereby indicating that the acquired rights to use are likely not properly distributed thereby triggering a redistribution.

In response to determination being negative, the method proceeds with redistributing 510 rights to use based on a predetermined scheme. In one embodiment, the user can configure the method to redistribute the acquired rights to use as is desired. Alternatively, the redistribution can be performed based on location history information and established distribution preferences as discussed above. Alternatively, each right to use can be assigned to a specific home location, and will be transferred back to that home location at redistribution time. Alternatively, each component could be queried as to whether that component is missing rights to use. Rights to use could then be transferred to the components that responded affirmatively to the query. In such an embodiment, if not enough rights to use are available for all components that responded affirmatively, then the components having the least amount of rights to use can be refreshed. Other rules or determinations can be contemplated as well, an will be apparent in light of this disclosure.

Recall that in the case where a component is unavailable at redistribution time, the redistribution related to that particular component can be queued (e.g., in a digital media sever). Once the component becomes available, the redistribution can occur. Note that in alternative embodiments, determination 505 can be eliminated where the redistribution of step 510 is automatically performed on a periodic basis regardless of what transfers have taken place. Likewise, such an automatic periodic redistribution can be used in addition to determination 505. Such an automatic periodic redistribution can be performed at off-peak hours for purposes of convenience and efficiency.

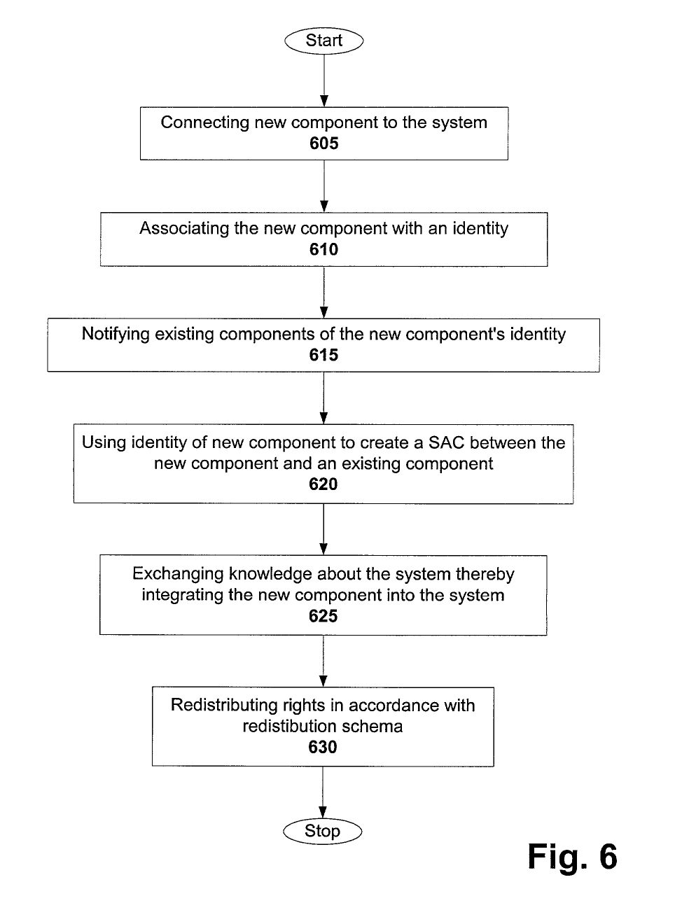

FIG. 6 illustrates a method for integrating a new component into a system for enabling protected media content to be shared between playback devices in accordance with one embodiment of the present invention. Such a method could be employed by a system such as the one illustrated in FIG. 1, though the method is not intended be limited to use with any one system or configuration. The method can be implemented, for example, in hardware, software, firmware or any combination thereof.

The method begins with connecting 605 a new component to the system. In order to prevent an unauthorized addition of a new component, a global level security code or access scheme can be employed. Unless, the proper code is activated, the method for integrating a new component will not engage. Similarly, new components can be registered for use only on a particular system based on, for example, a manufacture's code. In this way, a new component would have to be pre-configured by its manufacturer to operate with its target system. Other methods for locking out unauthorized additions will be apparent in light of this disclosure.

The method then proceeds with associating 610 the new component with an identity. This identity can be, for example, assigned by the user or generated by a conventional random code generator. The identity may be stored in the system (e.g., in a digital media server). The method may include notifying 615 existing components of the new component's identity. In one embodiment, this is accomplished by adding the new component's identity to a list of existing component identities. The list, which can be stored for reference (e.g., in a digital media player), can be consulted for verification purposes. In this way, each device on the list knows one another.

The method further includes using 620 the identity of the new component to create a SAC between the new component and an existing component, and exchanging 625 knowledge about the system thereby integrating the new component into the system. This can be accomplished by storing a file containing the system configuration information (e.g., on a media server or on the device itself). Such configuration information characterizes each component on the system and includes data such as the main function (e.g., music player, video player, display device) of each component, the identity of each component, the home-based media content and or associated user rights of each component, and the type of connection (e.g., temporary wireless SAC, permanent wired SAC) to the system for each component. Such system configuration information can alternatively be stored locally on each system component.

The method also includes redistributing 630 rights to use in accordance with system configuration rules or other suitable scheme. This may involve taking rights from one or more existing components that can spare rights to use so that the new component has those rights to use. Alternatively, the user can specify what rights to use, if any, will be transferred to the new component. Alternatively, the new component can be assigned a priority level that is higher than existing components on the system. As such, rights to use from those lower priority components will be transferred to the higher priority new device. Alternatively, rights to use will be transferred to the new component only if it is a digital media server. Numerous redistribution schemes when incorporating a new component will be apparent in light of this disclosure.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A media server comprising:
an input unit having a number of input ports for receiving media content;
an intake module operatively coupled to the media input unit for identifying rights to use associated with each piece of received media content;
a storage unit operatively coupled to the intake module for storing rights to use associated with the received media content; and
an outtake module operatively coupled to the storage unit and for securely transferring a right to use associated with a piece of media content to another location.

2. The media server of claim 1, wherein the input ports of the input unit are configured to receive diverse forms of media content including analog and digital media content.

3. The media server of claim 1, wherein the intake module performs analog to digital conversion on media content that is received in an analog form.

4. The media server of claim 1, wherein the intake module performs digital compression on the received media content, whether that media content was received in digital form or converted to digital form from a received analog form.

5. The media server of claim 1, wherein in response to the received media content not being associated with any rights to use, the intake module assigns a number of default rights to use.

6. The media server of claim 1, wherein in response to the received media content being encrypted, the intake module performs decryption on the received media content.

7. The media server of claim 1, wherein the intake module includes a central processing unit and a set of software instructions for carrying out functionality associated with the intake module.

8. The media server of claim 1, wherein the storage unit is for storing the received media content.

9. The media server of claim 1, wherein the storage unit includes a secure database for storing the rights to use associated with the received media content.

10. The media server of claim 1, wherein the outtake module establishes a secure communication channel between itself and a target location thereby facilitating the secure transfer of a right to use associated with a piece of media content to the target location.

11. The media server of claim 1, wherein the outtake module decompresses digitally compressed media content stored in the storage unit.

12. The media server of claim 1, wherein the outtake module is for securely transferring a piece of media content to another location.

13. The media server of claim 1, wherein the outtake module encrypts a right to use associated with a piece of media content before that right to use is transferred to another location.

14. The media server of claim 1, wherein the outtake module encrypts a piece of media content before that piece of media content is transferred to another location.

15. The media server of claim 1, wherein the outtake module includes a central processing unit and a set of software instructions for carrying out functionality associated with the outtake module.

16. The media server of claim 1, wherein the outtake module makes copies of stored media content.

17. The media server of claim 1, wherein the outtake module converts media content having a digital form to its analog equivalent and provides that analog equivalent to an analog output.

18. The media server of claim 17, wherein the media content converted from a digital form to its analog equivalent is an audio file, the media server further comprising:
an amplifier operatively coupled to the analog output for amplifying the analog equivalent;
a number of speakers operatively coupled to the amplifier for sounding out the analog equivalent.

19. The media server of claim 1, further comprising:
a buffer for queuing media content to be transferred to a target location in response to the target location being unavailable at transfer time.

20. A system for enabling protected media content to be shared between playback devices, the system comprising:
a media server for explicitly or implicitly transferring a right to use associated with a piece of media content to other locations on the system thereby allowing copies of that piece of media content to be used at the other locations; and
a playback device accessible by the media server, the playback device for allowing playback of the piece of media content given that the right to use associated with that piece of media content has been explicitly or implicitly transferred to the playback device.

21. The system of claim 20, wherein the right to use is explicitly or implicitly transferred between the media server and the playback device by a secure communication channel.

22. The system of claim 20, wherein a copy of the piece of media content is transferred from the media server to the playback device by a secure communication channel.

23. The system of claim 20, wherein a number of pieces of media content are stored in the media server.

24. The system of claim 20, wherein rights to use associated with a number of pieces of media content are stored in the media server.

25. The system of claim 20, further comprising:
a number of additional media servers and playback devices, wherein each component included in the system can be operatively coupled to at least one other component included in the system for the purpose of securely transferring rights to use a piece of media content between the coupled components.

26. The system of claim 20, further comprising:
a number of additional media servers and playback devices, wherein acquired rights to use associated with a particular piece of media content can be distributed among system components pursuant to a distribution scheme.

27. The system of claim 20, further comprising:
a number of additional media servers and playback devices, wherein rights to use associated with all acquired media content can be redistributed among system components pursuant to a redistribution scheme.

28. The system of claim 20, wherein the media server is operatively coupled to a network and can be securely accessed by a remote computer system.

29. The system of claim 20, wherein the media server is included in a computer system that is operatively coupled to a network and can receive downloads of media content.

30. A method for enabling protected media content to be shared between playback devices, the method comprising: receiving media content;
identifying rights to use associated with each piece of media content received; and
explicitly or implicitly transferring a right to use associated with a piece of media content to another location thereby allowing playback of that piece of media content at that location.

31. The method of claim 30, wherein receiving media content includes receiving diverse forms of media content including analog and digital media content.

32. The method of claim 30, further comprising:
in response to the received media content being in an analog form, converting the received media content to its digital equivalent.

33. The method of claim 30, further comprising:
digitally compressing the received media content, whether that media content was received in digital form or converted to digital form from a received analog form; and
storing the digital compressed media content.

34. The method of claim 30, further comprising:
in response to no rights to use being identified, assigning a number of default rights to use.

35. The method of claim 30, further comprising:
in response to the received media content being encrypted, decrypting the received media content.

36. The method of claim 30, further comprising:
storing the received media content.

37. The method of claim 30, further comprising:
storing identified rights to use.

38. The method of claim 30, further comprising:
establishing a secure communication channel to a target location thereby facilitating a secure transfer of a right to use associated with a piece of media content to the target location.

39. The method of claim 30, further comprising:
securely transferring a piece of media content to another location.

40. The method of claim 30, further comprising:
decompressing digitally compressed media content prior to transferring it to another location.

41. The method of claim 30, further comprising:
encrypting a right to use associated with a piece of media content before transferring it to another location.

42. The method of claim 30, further comprising:
encrypting a piece of media content before transferring it to another location.

43. The method of claim 30, further comprising:
making copies of media content for transfer to other locations.

44. The method of claim 30, further comprising:
converting media content having a digital form to its analog equivalent; and providing that analog equivalent to an analog output.

45. The method of claim 44, wherein the media content converted from a digital form to its analog equivalent is an audio file, the method comprising:
amplifying the analog equivalent; and
sounding out the analog equivalent.

46. The method of claim 30, further comprising:
in response to a target location being unavailable at transfer time, queuing media content to be transferred to that target location for transfer at a later time.

47. The method of claim 30, further comprising:
in response to a target location being unavailable at transfer time, queuing rights to use to be transferred to that target location for transfer at a later time.

48. The method of claim 30, further comprising:
recording the location history of a right to use associated with a piece of media content.

49. The method of claim 30, further comprising:
recording the location history of a piece of media content.

50. The method of claim 30, further comprising:
categorizing a number of pieces of media content based on factors including type of media content.

51. The method of claim 30, further comprising:
categorizing a right to use based on factors including type of media content to which the right to use is associated.

52. The method of claim 30, further comprising:
distributing the media content pursuant to a predetermined distribution scheme.

53. The method of claim 30, further comprising:
distributing rights to use pursuant to a predetermined distribution scheme.

54. The method of claim 30, further comprising:
distributing rights to use to playback devices pursuant to an established pecking order of the playback devices.

55. A method for maintaining a desired distribution of acquired rights to use associated with media content, the method comprising:
determining whether the acquired rights to use are properly distributed based on established indicators; and
in response to the acquired rights to use not being properly distributed, redistributing the rights to use based on a redistribution scheme.

56. The method of claim 55, further comprising:
in response to a target location being unavailable at redistribution time, queuing redistributed data bound for that target location until that location becomes available at a later time.

57. A method for integrating a new component into a system for enabling protected media content to be shared between playback devices, the method comprising:
connecting a new component to the system;
associating the new component with an identity;
notifying existing components of the new component's identity;
using the identity of new component to create a secure communication link between the new component and an existing component;
exchanging configuration information about the system thereby integrating the new component into the system; and
redistributing rights to use associated with the protected media content in accordance with system configuration rules.
